(19) United States
(12) Patent Application Publication
(10) Pub. No.: US 2018/0156060 A1
(43) Pub. Date: Jun. 7, 2018

(54) PULSE-OPTIMIZED FLOW CONTROL

(71) Applicant: IMPERIAL INNOVATIONS LIMITED, London (GB)

(72) Inventors: Ricardo Martinez-Botas, Twickenham (GB); Kun Cao, London (GB)

(21) Appl. No.: 15/579,550

(22) PCT Filed: Jun. 8, 2016
(86) PCT No.: PCT/GB2016/051685

§ 371 Date: Dec. 4, 2017

(30) Foreign Application Priority Data
Jun. 8, 2015 (GB) 1509873.4

(51) Int. Cl. F01D 17/12; F01D 9/04

(52) U.S. Cl. CPC F01D 17/12; F05D 2240/128; F05D 2220/40; F01D 9/041

(57) ABSTRACT

A flow-control assembly for guiding a flow of fluid having a variable mass flow rate onto a turbine comprising: a turbine comprising a blade and configured to rotate about an axis of rotation; and a flow-guidance element in fluid communication with the turbine and comprising a flow-guiding vane and configured to guide a flow of fluid at a relative fluid flow angle to rotate the turbine about the axis of rotation; wherein the flow-guidance element is configured to rotate about the same axis of rotation as the turbine so as to alter the variation of the relative fluid flow angle at turbine ingress arising from varying mass flow rate in the flow of fluid.

### FIELD

The present disclosure relates to a method and a flow-control assembly for guiding a flow of fluid having a variable mass flow rate onto a turbine. In embodiments, it also relates to a turbocharger comprising the flow-control assembly and to an engine comprising the turbocharger.

### BACKGROUND

Turbochargers for gasoline and diesel internal combustion engines make use of the heat and volumetric flow of exhaust gas exiting the engine for pressurising an intake air stream that is routed to a combustion chamber of the engine. Specifically, the exhaust gas exiting the engine is routed into a turbine of a turbocharger in a manner that causes an exhaust-gas-driven turbine to spin within the housing. The turbine is mounted on one end of a shaft that is common to a radial air compressor mounted on the other end of the shaft. Thus, rotary action of the turbine also causes the air compressor to spin within a compressor housing of the turbocharger that is separate from the exhaust housing. The spinning action of the air compressor causes intake air to enter the compressor housing and be pressurized before it is mixed with fuel and combusted within an engine combustion chamber.

Turbocharger technology is used extensively for various applications such as powering plants, vehicles, marine crafts, and other applications to enhance power output. In the example of a reciprocating internal combustion engine, the engine output may be increased by 40% or more by using the energy in the exhaust gas. Driven by the ever-growing stringent emission legislation in the past few decades, a renaissance of turbochargers is currently taking place in industry with recent developments in engine technology both for diesel and spark ignition engines.

A turbocharger turbine in an internal combustion engine is fed with continuously pulsating flow due to the nature of the exhaust flow of a reciprocating engine. It is generally acknowledged that the performance of the turbine deteriorates due to this pulsation. Critically, such a contradiction between the pulsating exhaust flow and the rotordynamic turbomachinary indicates that the turbocharger cannot harness the full energy potential contained in an unsteady flow of fluid and implies sub-optimal component choices, which lead to lower turbocharger performance and higher environmental overall impact. This issue implies the necessity to develop new technology with better performance both for turbochargers within combustion engines and more generally where the flow of fluid onto is variable.

### SUMMARY

According to a first aspect there is provided a flow-control assembly for guiding a flow of fluid having a variable mass flow rate onto a turbine comprising: a turbine comprising a blade and configured to rotate about an axis of rotation; and a flow-guidance element in fluid communication with the turbine and comprising a flow-guiding vane and configured to guide a flow of fluid at a relative fluid flow angle to rotate the turbine about the axis of rotation; wherein the flow-guidance element is configured to rotate about the same axis of rotation as the turbine so as to alter the variation of the relative fluid flow angle at turbine ingress arising from varying mass flow rate in the flow of fluid.

The inventors have recognised that systems such as turbocharging systems can be passive receivers of highly dynamic fluid flow, in particular fluid flow having a variable mass flow rate; for example, where the mass flow rate varies through an exhaust cycle of an internal combustion engine. However, designs for turbocharger systems, for example, can only make use of the steady turbomachinery component maps, thus forcing the design, matching and eventual installation of the systems along lines of quasi-steady operation.

A practical consequence introduced by the variation of mass flow rate of fluid onto the turbine is that the flow angle relative to the rotating blades of the turbine will deviate as the mass flow rate varies. Accordingly, the flow angle is not steady at a consistent, optimum point, leading to inefficiency. The first aspect is able to control the variation of the flow angle in order to address this. Normally it is difficult to control the relative flow directly as the turbine blade geometry is fixed. However, one can achieve a reduction in the variation of the relative flow angle by means of regulating the absolute flow angle by rotating a flow-guidance element in fluid communication with the turbine.

Incidence is defined as the difference between the relative inlet flow angle and the inlet blade angle:

I=β₃−β_{b} Equation 1

where β₃ is the relative flow angle at turbine ingress and β_{b} is the inlet blade angle of a turbine blade.

Since β_{b} is typically predefined, deviation in β₃ causes incidence loss which occurs where the turbine is operating “off-design”. Put another way, where the relative flow angle varies, the incidence value changes and loss of efficiency in converting energy into rotational energy at the turbine is exhibited. The cause of this efficiency reduction is the fluid flow impinging the solid blade and the subsequent flow separation and recirculation effect.

In order to address the problem, a new approach to guiding flow onto the turbine blades is set out. Unlike a traditional approach, in which a stationary nozzle ring is located around the circumference of a turbine, the flow-control assembly of the present disclosure is configured to rotate about the same axis of rotation as the turbine. The inception of this new flow control method is based on the fact that the variable magnitude of the unsteady exhaust flow can be converted into the variation of the absolute flow angle by means of a rotating flow-control assembly. Advantageously, it is therefore possible to reduce the variation in the relative flow angle and thereby improve the efficiency of the turbine.

According to a second aspect, there is provided a turbocharger comprising the flow-control assembly of the first aspect, wherein the flow of fluid is pulsed exhaust gas.

An example of an arrangement in which varying mass flow rate arrives at turbine ingress according to the prior art can be seen in FIG. 1 which relates to unsteady exhaust gas flow leaving an internal combustion engine.

In particular, as demonstrated in FIG. 1, the exhaust gas pressure at the exhaust manifold can be seen to cyclically pulse based upon the crank angle. Accordingly, the sequential operation of the internal combustion engine results in the exhaust gas leaving the engine having peaks and troughs of pressure. Accordingly, the mass flow rate of gas entering the turbocharger is not fixed and oscillates between a peak and a trough mass flow rate. This change in mass flow rate leads to a variation in the absolute flow velocity at turbine ingress and therefore the relative flow angle of the gas at the turbine, as the turbine rotates. Since the relative flow of the exhaust gas at turbine ingress varies according to the mass flow rate, the efficiency of the turbine is reduced where the relative flow angle of the turbine deviates from an optimized angle.

It will be appreciated that this sub-optimal deviation in the relative flow angle β₃ is caused by a change in the mass flow rate of the fluid at turbine ingress. Accordingly, the problem of reduced turbine efficiency is not restricted solely to turbochargers configured to receive exhaust gases from an internal combustion engine. Rather, this problem arises whenever the mass flow rate into a turbine varies or is unsteady.

Accordingly, the present disclosure has application beyond turbochargers for internal combustion engines and applies, more generally, to optimizing any irregular or varying mass flow rate of a fluid in which the relative flow angle of the fluid at turbine ingress varies with respect to the inlet blade angle β_{b} of a turbine.

Whilst the flow control assembly has application in a turbocharger, it will be appreciated that the flow-control assembly can be utilised in a number of different applications, such as gas and wind turbines. Other examples include aircraft engines which may be subjected to variable flow conditions.

According to a third aspect, there is provided an engine comprising a turbocharger according to the second aspect. According to a fourth aspect, there is provided a vehicle comprising an engine according to the third aspect.

Many different applications are envisaged for a turbocharger according to the second aspect. For example, the turbocharger may be used as part of an engine of a number of different types of vehicle, including a car, a track, a tractor, a tank, a motorcycle, a ship, a vessel, and other automotive vehicles.

According to a fifth aspect, there is provided a method for guiding a flow of fluid having a variable mass flow rate onto a turbine, the turbine comprising a blade and configured to rotate about an axis of rotation, the method using a flow-guidance element in fluid communication with the turbine, the flow-guidance element comprising a flow-guiding vane and configured to guide a flow of fluid at a relative fluid flow angle to rotate the turbine about the axis of rotation, the method comprising: rotating the flow-guidance element about the same axis of rotation as the turbine so as to reduce the variation of the relative fluid flow angle at turbine ingress arising from varying mass flow rate in the flow of fluid.

As will be appreciated, the variation of the relative fluid flow angle at turbine ingress arising from varying mass flow rate in the flow of fluid may be reduced by rotating the flow-guidance element about the same axis of rotation as the turbine.

The turbine may comprise a plurality of blades and wherein the flow-guidance element comprises a plurality of flow-guiding vanes displaced from one another.

The rotation of the turbine and the flow-guidance element may be in the same direction about the axis of rotation or may be in different directions about the axis of rotation.

The rotation of the flow-guidance element may be controlled by an actuator. The actuator may be configured to vary the speed of rotation of the flow-guidance element based upon the mass flow rate of the flow of fluid. The actuator may be configured to rotate the flow-guidance element at a higher speed at peak mass rate flow than at trough mass flow rate. The actuator may be configured to rotate the flow-guidance element at a lower speed at peak mass flow rate than at trough mass flow rate.

The actuator may be configured to rotate the flow-guidance element at a fixed speed. The fixed speed may be less than or equal to the rotation speed of the turbine and may be less than or equal to 150 revolutions per second.

The rotation of the flow-guidance element may be driven by the flow of fluid.

The flow-guidance element may be in the form of a ring and may be positioned around the circumference of the turbine.

The flow-guidance element may be axially displaced with respect to the turbine. In such cases, the turbine may be an axial turbine.

### BRIEF DESCRIPTION OF THE DRAWINGS

Embodiments will be described below, by way of example only, with reference to the accompanying drawings, in which:

FIG. 1 is a graph illustrating exhaust pressure traces in an internal combustion engine manifold with automotive-type valve timing;

FIG. 2 is a cross-sectional view of a flow-control assembly according to an example;

FIG. 3a is a velocity triangle diagram illustrating fluid velocity through a stationary prior art nozzle ring at trough mass flow rate;

FIG. 3b is a velocity triangle diagram illustrating fluid velocity at a rotating turbine having been passed through the stationary prior art nozzle ring of FIG. 3a at trough mass flow rate;

FIG. 4a is a velocity triangle diagram illustrating fluid velocity through a stationary prior art nozzle ring at peak mass flow rate;

FIG. 4b is a velocity triangle diagram illustrating fluid velocity at a rotating turbine having been passed through the stationary prior art nozzle ring of FIG. 4a at peak mass flow rate;

FIG. 5a is a velocity triangle diagram illustrating fluid velocity through a rotating flow-guidance element according to an example of the present disclosure at trough mass flow rate;

FIG. 5b is a velocity triangle diagram illustrating fluid velocity at a rotating turbine having been passed through the rotating flow-guidance element of FIG. 5a at trough mass flow rate;

FIG. 6a is a velocity triangle diagram illustrating fluid velocity through a rotating flow-guidance element according to an example of the present disclosure at peak mass flow rate;

FIG. 6b is a velocity triangle diagram illustrating fluid velocity at a rotating turbine having been passed through the rotating flow-guidance element of FIG. 6a at peak mass flow rate;

FIG. 7 is a combined velocity triangle diagram illustrating fluid velocities at a rotating turbine according to FIGS. 5b and 6b;

FIG. 8a illustrates turbine stage efficiency as a function of the rotation speed of the flow-guidance element in both turbo and compressor modes at trough mass flow rates;

FIG. 8b illustrates turbine stage efficiency as a function of the rotation speed of the flow-guidance element in both turbo and compressor modes at peak mass flow rates;

FIG. 9a illustrates power output as a function of the rotation speed of the flow-guidance element in both turbo and compressor modes at trough mass flow rates; and

FIG. 9b illustrates power output as a function of the rotation speed of the flow-guidance element in both turbo and compressor modes at peak mass flow rates.

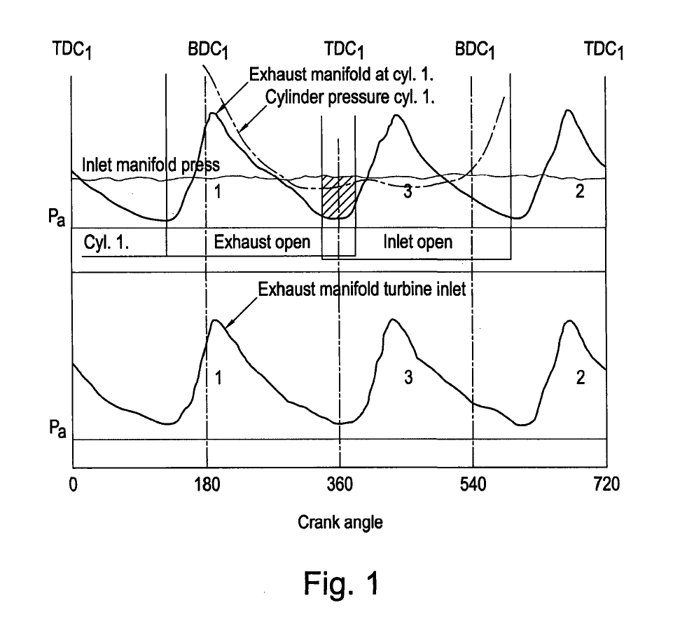

### DETAILED DESCRIPTION

The following embodiments relate generally to a flow-control assembly for guiding a flow of fluid onto a turbine so as to rotate the turbine.

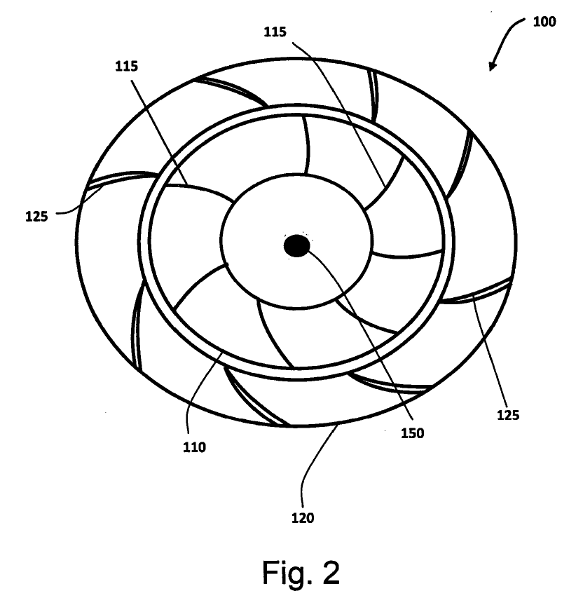

A cross-sectional view of a flow-control assembly 100 according to an example of the present disclosure is illustrated in FIG. 2. The flow-control assembly 100 comprises a turbine 110 which is configured to rotate about an axis of rotation 150. The turbine 110 comprises at least one blade 115 configured to cause the turbine 110 to rotate about the axis 150 in response to a flow of fluid across the blades 115.

Flow-control assembly 100 further comprises a flow-guidance element 120 in fluid communication with the turbine 110 and comprising at least one flow-guiding vane 125 separated about the circumference of the flow-guidance element 120. The flow-guiding vanes 125 are shaped elements, such as nozzles, which guide the fluid on to the blades 115 of the turbine 110. The flow-guidance element 120 may take the form of a nozzle ring having one or more nozzles which act to guide the fluid flow to turbine ingress.

The vanes 125 and the blades 115 may comprise pressure and suction surfaces so as to act as aerofoils.

The flow-guidance element 120 is arranged upstream of the turbine 110 and is configured to guide a flow of fluid onto the blades 115 of the turbine in order to rotate the turbine about the axis of rotation 150.

The flow-guidance element 120 is configured to rotate about the same axis of rotation as the turbine 110 so as to alter or reduce the variation of the relative fluid flow angle at turbine ingress arising from varying mass flow rate in the flow of fluid.

In the example of FIG. 2, the flow-guidance element 120 is positioned about the external circumference of the turbine 110 in order to guide fluid arriving at the circumference of the turbine 110 onto the blades 115 of the turbine 110. For example, a turbocharger for an internal combustion engine may include a flow-control assembly arranged as illustrated in FIG. 2.

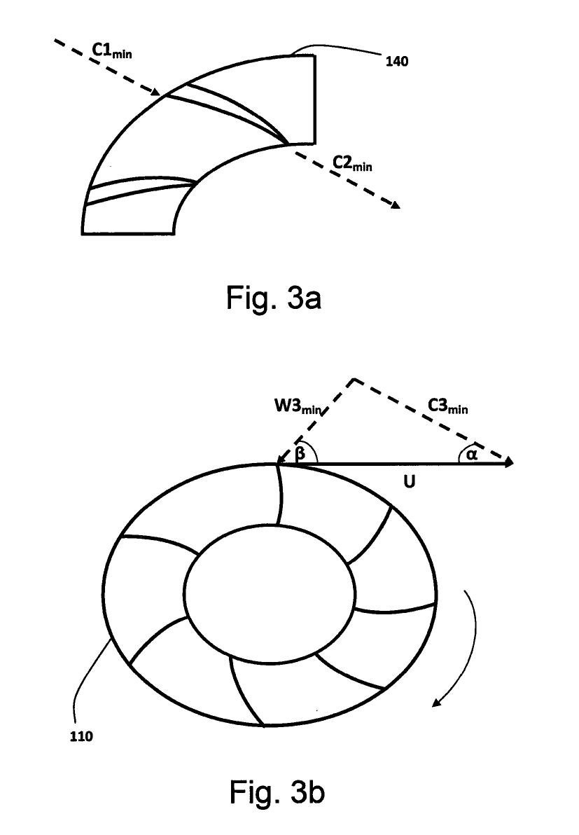

As discussed above, inefficient operation of the turbine may occur where the flow angle β₃ of the fluid relative to the rotation of the blades is sub-optimal. This variation in the relative flow angle is demonstrated in further detail with respect to FIGS. 3a, 3b, 3c, and 3d.

In prior art arrangements a stationary nozzle ring 140 may be placed around the circumference of a turbine. FIG. 3a illustrates a velocity triangle for such a prior art nozzle ring 140, where the nozzle ring is located around the circumference of a turbine. Unlike the arrangement of FIG. 2, the prior art nozzle ring 140 of FIG. 3a is fixed with respect to the axis of rotation and is therefore unable to rotate.

In the arrangement of FIG. 3a, the absolute flow velocity of fluid flowing into the stationary nozzle ring 140 at trough mass flow rate is defined as C1ₘᵢₙ. As also illustrated in FIG. 3a, the absolute flow velocity of fluid flowing out of the stationary nozzle ring 140 at trough mass flow rate is defined as C2ₘᵢₙ. The flow angle relative to the nozzle ring 140 is not shown since the relative flow angles into and out of the nozzle ring 140 are the same as the corresponding absolute values, as the nozzle ring 140 is stationary.

In FIG. 3b, the fluid having passed through the nozzle ring of FIG. 3a arrives at turbine ingress. The absolute flow velocity of fluid flowing onto the rotating turbine 110, i.e. at turbine ingress, is defined as C3ₘᵢₙ. The flow velocity (m/s) of the fluid flowing onto the rotating turbine 110 relative to the speed of rotation U of the turbine 110 is defined by W3ₘᵢₙ. As defined by FIG. 3b, the absolute flow angle α and relative flow angle β is determined based upon the speed of rotation of the turbine and the absolute flow velocity C3ₘᵢₙ.

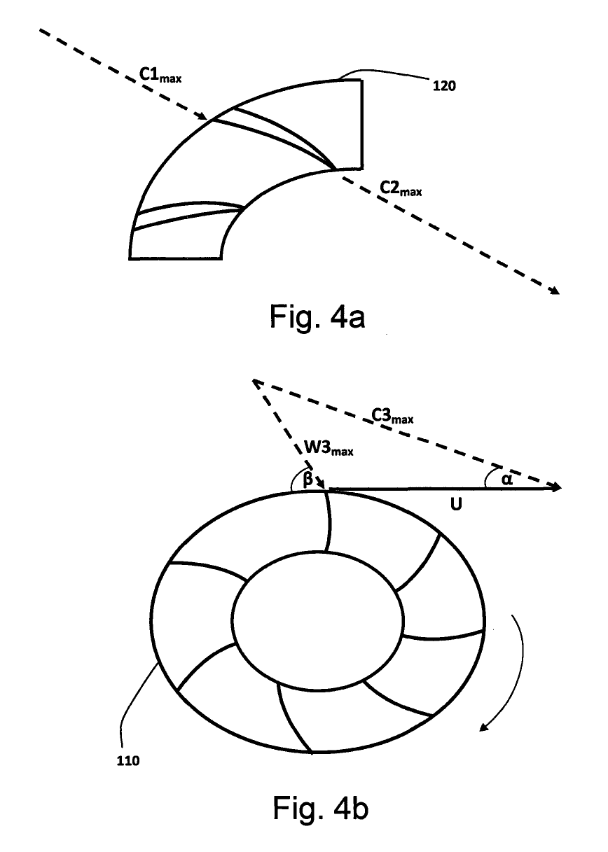

The arrangement of FIGS. 3a and 3b show the relative flow angle of the fluid at trough mass flow rate of the fluid. FIGS. 4a and 4b illustrate velocity triangles for an arrangement which corresponds to that of FIGS. 3a and 3b, apart from the mass flow rate of the fluid being at peak mass flow rate rather than at trough mass flow rate.

FIG. 4a illustrates the absolute flow velocities into C1ₘₐₓ and out of C2ₘₐₓ the fixed nozzle ring 140. FIG. 4b also illustrates the absolute flow velocity C3ₘₐₓ flowing onto the rotating turbine 110.

FIG. 4b also shows the flow velocity W3ₘₐₓ of the fluid flowing onto the rotating turbine 110 relative to the speed of rotation U of the turbine 110. As can be seen from FIGS. 3a and 4a, the absolute flow velocity at peak mass flow rate C2ₘₐₓ is larger than the absolute flow velocity at trough mass flow rate C2ₘᵢₙ. Accordingly, the relative flow velocity W3ₘₐₓ and W3ₘᵢₙ at turbine ingress differs depending upon the absolute flow velocity of the fluid at turbine ingress. Accordingly, the relative flow velocity at any given point is between W3ₘₐₓ and W3ₘᵢₙ.

As can be seen from the arrangements of FIGS. 3b and 4b, the relative flow angle β at turbine ingress varies depending upon the mass flow rate. Any deviation from the optimal relative flow angle onto the blades 115 of the turbine 110 will result in inefficient operation of the turbine due to incidence loss (see Equation 1). Accordingly, it is desirable to reduce the variation in β so as to increase the efficiency of the turbine 110.

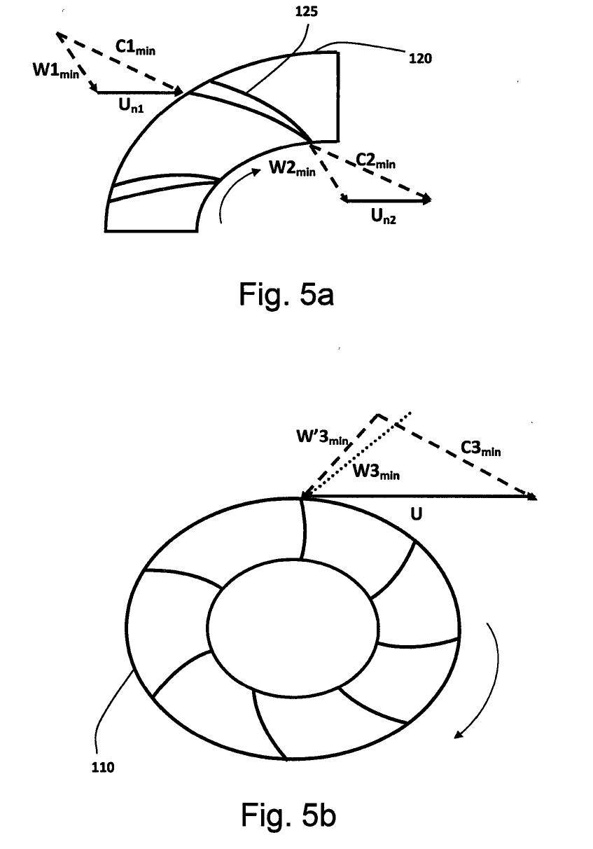

FIG. 5 illustrates an example of a flow-control assembly according to the present disclosure in which the flow-guidance element 120 comprises at least one vane 125 configured to guide fluid flow onto the blades 115 of the turbine 110. In the arrangement of FIG. 5, a velocity triangle diagram is shown for a flow-control assembly 120 configured to rotate at speed Uₙ₁.

FIG. 5a illustrates an arrangement in which fluid enters the rotating flow-guidance element 120 at trough mass flow rate and at an absolute flow velocity C1ₘᵢₙ and relative flow velocity W1ₘᵢₙ. As will be appreciated, the relative flow angle W1ₘᵢₙ entering the rotating flow-guidance element 120 of FIG. 5a is different to that experienced by the stationary nozzle 140 of FIG. 3a since the flow-guidance element 120 is rotating. The absolute flow leaving the flow-guidance element 120 is demonstrated in FIG. 5a as C2ₘᵢₙ and the flow of fluid relative to the flow-guidance element 120 is defined as W2ₘᵢₙ. FIG. 5b illustrates the resultant absolute C3ₘᵢₙ and relative W′3ₘᵢₙ flow velocities at turbine ingress. As can be seen from FIG. 5b, the relative flow angle of the fluid at trough mass flow rate with respect to the turbine 110 is altered when compared with the corresponding flow angle arriving at the turbine blades where the nozzle ring 140 of FIG. 3 is used in place of the illustrative flow-control assembly of FIG. 5.

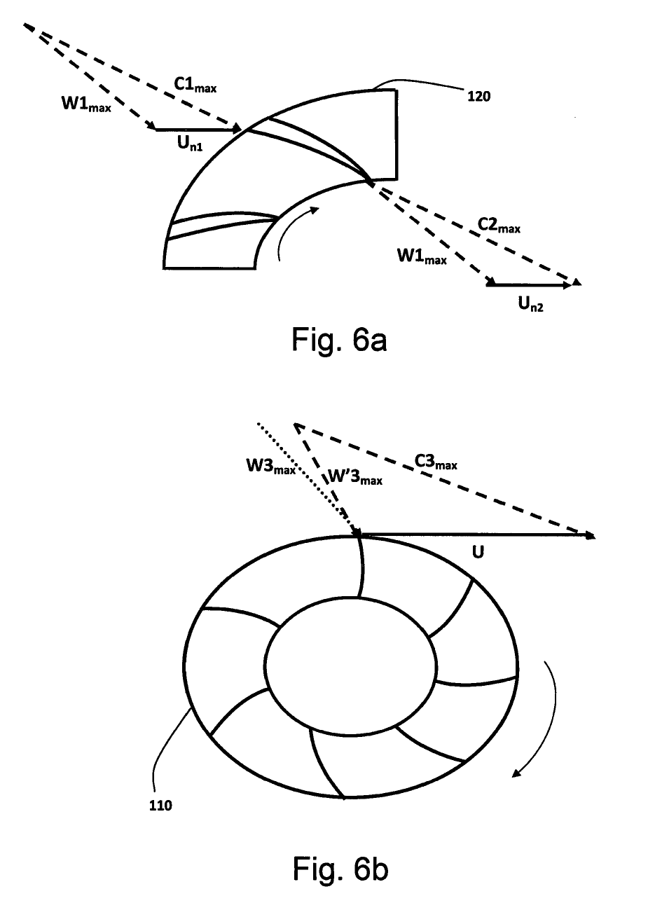

The corresponding arrangement for peak mass flow rate is illustrated in FIG. 6a, which defines the absolute C1ₘₐₓ and relative W1ₘₐₓ flow velocities into and absolute C2ₘₐₓ and relative W2ₘₐₓ flow velocities out of the flow-guidance element. Similarly, due to the rotation of the flow-control assembly 120, the relative flow angle experienced by the turbine 110 at peak mass flow rate is altered when compared with the corresponding flow angle at turbine ingress where the prior art nozzle ring 140 of FIG. 3 is used in place of the flow-guidance element 120 of FIG. 5.

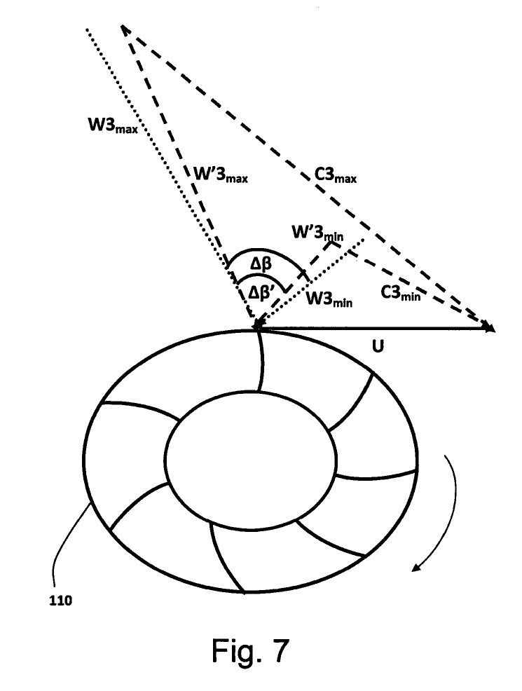

The relative and absolute flow angles at both peak and trough mass flow rates illustrated in FIGS. 5b and 6b have been superimposed in FIG. 7 for illustrative purposes.

In FIG. 7, the variation of the relative flow angle for the arrangement in which the stationary nozzle ring 140 is used (see FIG. 3) is illustrated by Δβ. Similarly, the variation in relative flow angle between peak and trough mass flow rate for the arrangement using the flow-control assembly 120 is illustrated by Δβ′.

As can be seen, from FIG. 7, Δβ′ is less than Δβ. Put another way, the overall variation in the relative flow angle at turbine ingress is reduced when the flow-guidance element 120 is used in place of a stationary nozzle ring 140. Accordingly, the efficiency of the turbine is increased.

The absolute flow of fluid out of the flow-guidance element 120 and at turbine ingress is more tangential at trough mass flow rate than the case with a stationary nozzle ring 140. Similarly, the absolute flow at of fluid out of the flow-guidance element 120 and at turbine ingress is more radial at peak mass flow rate than the case with a stationary nozzle ring 140. Accordingly, the variation in relative flow angle at turbine ingress is reduced.

Rotation Mode

As set out in the above examples, the flow-control assembly 120 is configured to rotate about the same axis of rotation as the turbine 100 so as to guide the inbound fluid onto the blades 115 of the turbine 110. Different approaches to rotating the flow-control assembly 120 about the axis of rotation are envisaged and are set out below in further detail.

In a first mode of rotation, an external actuator is used to drive the rotation of the flow-guidance element 120 about the axis of rotation. In this first mode, the layout of the pressure and suction surfaces of the flow-guidance vanes 125 is opposed to that of the blades 115 of the turbine 110. As fluid flows over the flow-guidance vanes 125, the direction of torque imposed on the flow-guidance element 120 by the pressure difference between the pressure and suctions surfaces of the flow-guiding vanes 115 is opposite to that of the turbine 110. Accordingly, the external actuator is used to overcome the negative torque and to enable the flow-guidance element 120 to rotate favourably to the turbine. This arrangement is referred herein as the “Compressor Mode”.

The actuator may be any externally powered means of rotating the flow-guidance element about the axis of rotation, such as an electric motor.

The compressor mode is advantageous since it is possible to control, using the actuator, the speed of rotation of the flow-guidance element 120 about the axis of rotation. However, the flow-guidance element 120 powered in this way can be considered to be an energy consumer since external power is needed to rotate the flow-guidance element 120.

The flow-guiding vanes 125 of the flow-guidance element 120 may be configured as a “forward vane” or a “backward vane” when used in the externally powered compressor mode. Specifically, the “forward vane” is configured to rotate the flow-guidance element 120 favourably to the upstream exhaust flow whilst the “backward vane” is configured to rotate the flow-guidance element 120 towards the exhaust flow.

In a different, second mode of operation, it is not necessary to provide external power to cause rotation of the flow-guidance element 120. Instead, the flow-guiding vanes 125 are configured such that the positions of the pressure and suction surfaces differ from the above-described compressor mode so that the direction of the torque imposed on the vanes 125 by the pressure difference between the pressure and suction surfaces is the same as the turbine 110 torque. Accordingly, the flow-guidance element 120 is able to rotate favourably to the turbine 110 without the need for an external actuator. The fluid flow passing over the flow-guiding vanes 125 causes the flow-guidance element 120 to rotate. This arrangement is referred to herein as “Turbo Mode”,

Rotation Direction

It is also possible to select the direction of rotation of the flow-guidance element 120 relative to the direction of rotation of the turbine 110 so as to adapt the relative flow angle at turbine 110 ingress.

Specifically, there are four possible configurations based upon the above-described forward vane and backward vane.

A first configuration is to use a forward vane on a flow-guidance element 120 rotating in the same rotational direction as the turbine; a second configuration is to use a forward vane on a flow-guidance element 120 rotating in an opposing rotational direction to the turbine; a third configuration is a backward vane on a flow-guidance element 120 rotating in the same rotational direction as the turbine; and a fourth configuration is to use a backward vane on a flow-guidance element 120 rotating in an opposing rotational direction as the turbine.

All of these four configurations are able to adjust the flow angle adaptively according to the varying mass flow rate. The difference between the configurations is the direction of the flow angle adjustment. With the first and second configurations, the flow angle out of the flow-guidance element 120 will be bigger in low mass flow rate than in high mass flow rate.

With the third and fourth configurations, the flow angle out of the flow-guidance element 120 is smaller in low mass flow rate than in high mass flow rate, which may not be suitable for turbocharger turbine, but may have suitability for other applications.

The skilled person will recognize that external power sources may be used to actuate the movement of the flow guidance element 120 according to design requirements.

Rotation Speed

In some arrangements, the rotation speed of the flow-guidance element 120 may be constant. For example, the flow-guidance element 120 may be rotated by an actuator at any rotation speed greater than zero revolutions per second and up to the rotation speed of the turbine 110.

As indicated by the velocity triangle analysis of FIGS. 5 to 9, higher rotation speed will generally increase the advantageous reduction in the variation of relative angle flow. However, the incidence loss on the flow-guidance element will also increase along with the increasing flow guidance element rotation speed, and the friction loss in a real application will also increase. These losses will counterbalance the benefits of a flow-guidance element. Therefore, it is preferable that the rotation speed of the nozzle is less than or equal to 150 revolutions per second. However, other rotations speeds are envisaged.

It is also possible to control the variation in relative flow angle at turbine ingress using a variable rotational speed.

A first approach for controlling the deviation in relative flow angle β₃ is to rotate the flow-guidance element 120 at a lower rotational speed when the mass flow rate into the flow-guidance element 120 is at its peak compared with the rotational speed of the flow-guidance element 120 at trough mass flow rate.

A second approach for controlling the deviation in relative flow angle β₃ is to rotate the flow-guidance element 120 at a higher rotational speed when the mass flow rate into the flow-guidance element 120 is at its peak compared with the rotational speed of the flow-guidance element 120 at trough mass flow rate.

With the first approach, the absolute flow angle out of the flow-guidance element 120 will be larger at trough mass flow rate and smaller at high mass flow rate, compared with a fixed nozzle ring or a flow-guidance element 120 at a constant rotational speed.

This will introduce a further reduction in the varying relative flow angle and therefore increase the efficiency of the turbine rotation. With the second approach, the absolute flow angle out of the flow-guidance element 120 will be smaller at trough mass flow rate and larger at peak mass flow rate, compared with a fixed rotational speed. Whilst this approach may not be advantageous for a turbocharger turbine, the arrangement has suitability for other applications.

In an arrangement, the flow-guidance element is static under peak mass flow, and as the mass flow rate decreases it gradually speeds up until it achieves peak rotational speed under trough mass flow rate, and then it slows down again as the mass flow rate increases. It can be observed that with this method the relative flow direction at the inner turbine inlet can be maintained exactly at the design point, which is companied by peak turbine efficiency.

Calculation Results

A computational fluid dynamics (CFD) model was used to simulate the performance of an example flow-control assembly of the present disclosure. The following parameters of the turbine were used:

| Parameter | Value | |
|---|---|---|
| Leading edge tip diameter | 95.14 | mm |
| Leading edge span height | 18 | mm |
| Trailing edge tip diameter | 78.65 | mm |
| Leading edge span height | 25.79 | mm |
| Cone angle | 40 | degrees |
| Leading edge blade angle | −20 | degrees |
| Root mean radius at trailing edge blade | 52 | degrees |
| angle | | |
| Length of axial chord | 40 | mm |
| Number of rotor blades | 12 | |
| Tip gap height (blade span) | 5% | |
| Volute exit flow angle | 68 | degrees |

The two main components of the CFD model, namely the flow-guidance element and the turbine, were meshed with a structure hexahedral mesh giving the following mesh statistics for each component:

| Region | Element Type | Nodes |
|---|---|---|
| Flow-guidance element | Hexahedral | 383742 |
| Turbine | Hexahedral | 636603 |
| Total | Hexahedral | 1020345 |

To simulate the varying mass flow rates into the flow-control assembly, the following boundary conditions and setup parameters were used:

| Boundary Condition | Value | |
|---|---|---|
| Type of analysis | Steady-state | |
| Non-dimensional turbine speed | 80% | |
| Fluid | Air Ideal Gas | |
| Residual value of parameters | 1e−06 | |
| Mesh connection | Frozen rotor | |
| Turbulence Model | k-epsilon | |
| Cp | 1004 | J/kgK |
| Non-dimensional mass flow rate | 60-100% | |
| Inlet total temperature | 338 | K |
| Inlet flow directions | 68 | degrees |
| Exit average static pressure | 1 | atm |

It will be appreciated that the above parameters are merely used for the purposes of simulating the performance of the flow-control assembly. The above parameters should not be taken to be limiting and many different parameters may be varied without affecting the performance of the flow-control assembly.

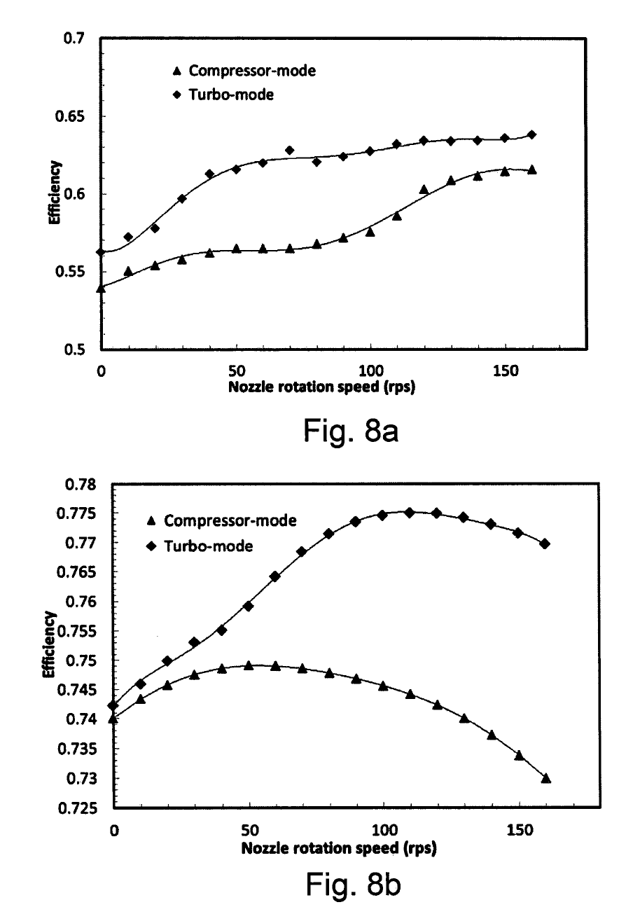

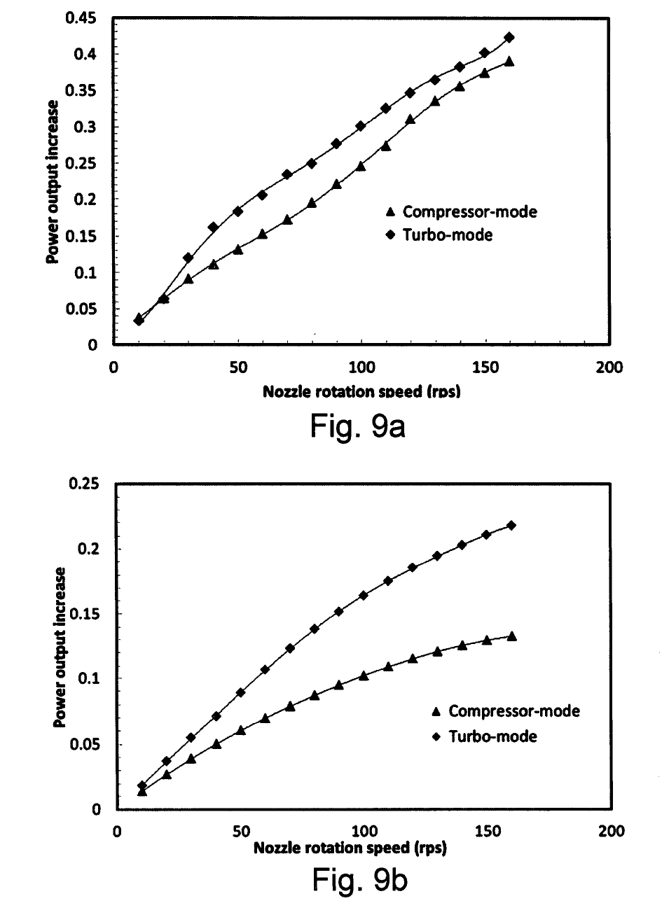

The model was used to evaluate the above-described compressor and turbine modes of rotation and the results of the evaluation of these modes can be seen in FIGS. 8a, 8b, 9a, and 9b.

An evaluation of efficiency of the flow-control assembly is shown in FIGS. 8a and 8b, which illustrates the efficiency of the turbine stage as a function of rotation speed of the flow-guidance element 120, in this instance a nozzle ring. FIG. 8a illustrates the turbine stage efficiency at trough mass flow rate and FIG. 8b illustrates the turbine stage efficiency at peak mass flow rate.

As can be seen from the simulation results, the flow-control assembly operating in turbo-mode provides particularly increased efficiency where the flow-guidance element rotates at 120 rps. This arrangement provides a 7.2% efficiency increase at trough mass flow and a 3.3% efficiency increase at peak mass flow. In compressor mode, the flow-control assembly provides particularly increased efficiency at 50 rps, with a 2.5% efficiency increase at trough mass flow rate and a 0.9% increase at peak mass flow rate.

FIGS. 9a and 9b show that the power output of the turbine is also increased using both the above-described turbo mode and compressor mode. In compressor mode, the power increase at 50 rps, which can be considered the best-performance point, is 13.1% at trough mass flow and 6.04% at peak mass flow. In turbo mode, the power increase at 120 rps is 34.7% at trough mass flow and 18.5% at peak mass flow.

The flow-guidance element 120 may be physically separated from the turbine 110. The flow-guidance element 120 may be configured to rotate independently of the turbine 110.

The relative physical arrangement of the turbine 110 and the flow-guidance element 120 set out in FIG. 2 is not essential and other arrangements are conceivable. Specifically, in some arrangements the fluid flow onto the blades may be substantially parallel with the axis of rotation of the turbine 110 and the flow-guidance element 120, for example in aerospace applications. In such arrangements, the flow-guidance element 120 may be axially displaced from the turbine 110. Accordingly, the flow-guidance element 120 may axially guide fluid onto the blades 115 of the turbine 110.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination. It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. A flow-control assembly for guiding a flow of fluid having a variable mass flow rate onto a turbine comprising:
a turbine comprising a blade and configured to rotate about an axis of rotation; and
a flow-guidance element in fluid communication with the turbine and comprising a flow-guiding vane and configured to guide a flow of fluid at a relative fluid flow angle to rotate the turbine about the axis of rotation;
wherein the flow-guidance element is configured to rotate about the same axis of rotation as the turbine so as to alter the variation of the relative fluid flow angle at turbine ingress arising from varying mass flow rate in the flow of fluid.

2. A flow-control assembly according to claim 1, wherein the variation of the relative fluid flow angle at turbine ingress arising from varying mass flow rate in the flow of fluid is reduced.

3. A flow-control assembly according to claim 1, wherein the turbine comprises a plurality of blades and wherein the flow-guidance element comprises a plurality of flow-guiding vanes displaced from one another.

4. A flow-control assembly according to any of claim 1, wherein the rotation of the turbine and the flow-guidance element is in the same direction about the axis of rotation.

5. A flow-control assembly according to any of claim 1, wherein the rotation of the turbine and the flow-guidance element is in different directions about the axis of rotation.

6. A flow-control assembly according to claim 1, wherein the rotation of the flow-guidance element is controlled by an actuator.

7. A flow-control assembly according to claim 6, wherein the actuator is configured to vary the speed of rotation of the flow-guidance element based upon the mass flow rate of the flow of fluid.

8. A flow-control assembly according to claim 6, wherein the actuator is configured to rotate the flow-guidance element at a higher speed at peak mass rate flow than at trough mass flow rate.

9. A flow-control assembly according to claim 6, wherein the actuator is configured to rotate the flow-guidance element at a lower speed at peak mass flow rate than at trough mass flow rate.

10. A flow-control assembly according to claim 6, wherein the actuator is configured to rotate the flow-guidance element at a fixed speed.

11. A flow-control assembly according to claim 10, wherein the fixed speed is less than or equal to the rotation speed of the turbine.

12. A flow-control assembly according to claim 10, wherein the fixed speed is or equal to 150 revolutions per second.

13. A flow-control assembly according to any of claim 1, wherein the rotation of the flow-guidance element is driven by the flow of fluid.

14. A flow-control assembly according to claim 1, wherein the flow-guidance element is in the form of a ring and is positioned around the circumference of the turbine.

15. A flow-control assembly according to any of claim 1, wherein the flow-guidance element is axially displaced with respect to the turbine.

16. A turbocharger comprising:
a turbine comprising a blade and configured to rotate about an axis of rotation; and
a flow-guidance element in fluid communication with the turbine and comprising a flow-guiding vane and configured to guide a flow of fluid at a relative fluid flow angle to rotate the turbine about the axis of rotation;
wherein the flow-guidance element is configured to rotate about the same axis of rotation as the turbine so as to alter the variation of the relative fluid flow angle at turbine ingress arising from varying mass flow rate in the flow of fluid, wherein the flow of fluid is pulsed exhaust gas.

17. An engine comprising:
a turbocharger comprising
a turbine comprising a blade and configured to rotate about an axis of rotation; and
a flow-guidance element in fluid communication with the turbine and comprising a flow-guiding vane and configured to guide a flow of fluid at a relative fluid flow angle to rotate the turbine about the axis of rotation;
wherein the flow-guidance element is configured to rotate about the same axis of rotation as the turbine so as to alter the variation of the relative fluid flow angle at turbine ingress arising from varying mass flow rate in the flow of fluid.

18. A vehicle comprising:
an engine comprising
a turbine comprising a blade and configured to rotate about an axis of rotation; and
a flow-guidance element in fluid communication with the turbine and comprising a flow-guiding vane and configured to guide a flow of fluid at a relative fluid flow angle to rotate the turbine about the axis of rotation;
wherein the flow-guidance element is configured to rotate about the same axis of rotation as the turbine so as to alter the variation of the relative fluid flow angle at turbine ingress arising from varying mass flow rate in the flow of fluid.

19.-33. (canceled)
